(19) United States
(12) Patent Application Publication
(10) Pub. No.: US 2006/0123434 A1
(43) Pub. Date: Jun. 8, 2006

(54) Disc changer and disc discriminating device thereof

(75) Inventor: Chih-Hsuan Shih, Taipei (TW)

Correspondence Address: BIRCH STEWART KOLASCH & BIRCH, PO BOX 747, FALLS CHURCH, VA, 22040-0747, US

(73) Assignee: Lite-On It Corporation

(21) Appl. No.: 11/292,139

(22) Filed: Dec. 2, 2005

(30) Foreign Application Priority Data
Dec. 2, 2004 (TW) 93137248

(51) Int. Cl. G11B 17/04; G11B 17/03; G11B 33/02

(52) U.S. Cl. 720/606

(57) ABSTRACT

A disc discriminating device disposed in a disc changer is provided. The disc changer includes at least a tray having a recess. The disc discriminating device includes a sensing circuit and a conductor. The sensing circuit has a first contact and a second contact. The sensing circuit accordingly outputs a signal when the first and second contacts are electrically connected. The conductor has a first end electrically connected to the first contact, a protrusion penetrating an aperture disposed on a sidewall of the recess and protruding to the recess, and a second end interspaced by an interval with the second contact. The protrusion outside the recess is squeezed by a disc when loading into the recess, so that the second end of the conductor is electrically connected to the second contact. The sensing circuit outputs a signal according to the above conduction.

This application claims the benefit of Taiwan Application Serial No. 093137248, filed Dec. 2, 2004, the subject matter of which is incorporated herein by reference.

### BACKGROUND OF THE INVENTION

1. Field of the Invention

The invention relates in general to a disc changer, and more particularly to a disc discriminating device of the disc changer.

2. Description of the Related Art

In recent years, with the features of high record density, long lifespan, small size, low cost and applicability even in the presence of the dusts being deposited on the surface, optical disc has thus become an important data storage media, and optical disc drive a most widely used read/write device. For the convenience of use, some optical disc drives have a disc changer disposed therein. The disc changer is capable of receiving several optical discs at the same time. The only thing the user needs to do is to press a button to complete the tedious task of returning the just-played optical disc to the waiting position and placing the selected optical disc at the read position.

A conventional optical disc drive with disc changer at least includes a cartridge, a drive motor and an optical pick-up head. The cartridge is removably disposed in the disc changer. The cartridge has several trays used for carrying several optical discs, and the bottom surface of each tray has an aperture disposed thereon. The drive motor is used for driving the tray into/from the cartridge. The optical pick-up head is adjacent to the cartridge. Once the cartridge containing an optical disc is loaded into the disc changer, the drive motor carries the trays from inside the cartridge to atop the optical pick-up head. The optical pick-up head reads the data in the disc through the aperture to determine whether the tray has a disc.

However, as more optical discs are placed in the cartridge, more time would be required to determine whether each tray has an optical disc loaded therein. Besides, in the course of reciprocal movement, components such as tray, slide channel, disc retriever are likely to run down, reducing the lifespan of the disc changer. Furthermore, if a small-sized optical disc, an 8 cm disc for instance, slides into optical disc drive through the aperture of the tray in the course of moving to the read position, the parts of the device may be damaged or jammed, and the disc may be locked and cannot be released.

### SUMMARY OF THE INVENTION

It is therefore an object of the invention to provide a disc changer whose disc discriminating device respectively determines whether each tray has a suitable optical disc immediately after a disc is loaded. In addition, the determining process is completed immediately without carrying the tray out of the cartridge.

According to the object of the invention, a disc discriminating device disposed in a disc changer is provided. The disc changer at least includes a tray having a recess. The disc discriminating device includes a sensing circuit and a conductor. The sensing circuit has a first contact and a second contact. The sensing circuit is conducted and accordingly outputs a signal signifying that the recess has a disc loaded therein when the first contact is electrically connected to the second contact. The conductor has a first end, a protrusion and a second end. The first end is electrically connected to the first contact. The second end and the second contact are separated by an interval when the protrusion protrudes to the recess. The disc squeezes the protrusion to be outside the recess when a disc is loaded into the recess, so that the second end is electrically connected to the second contact. Hence the first contact is conducted to the second contact, the sensing circuit outputs the signal.

According to another object of the invention, a disc changer including several trays, a disc discriminating device and a control system is provided. The several trays are stacked up with the bottom surface of one tray facing the top surface of the next tray. The disc discriminating device has several sensing components respectively corresponding to the trays. When a disc is loaded into the tray, the disc discriminating device immediately determines whether each tray has a disc loaded therein and outputs several signals accordingly. The control system receives the signals and then drives the trays accordingly for the disc to be placed at a read position.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a 3-D diagram of a disc changer according to a preferred embodiment of the invention;

FIG. 2 is a top view of the disc changer of FIG. 1;

FIG. 3 is a partial enlarged diagram of a disc discriminating device when no disc is loaded into the disc changer of FIG. 2;

FIG. 4 is a partial enlarged diagram of a disc discriminating device showing a disc is loaded into the disc changer of FIG. 2; and

FIGS. 5A and 5B are top views showing a small-sized disc is loaded into the disc changer according to the embodiment.

### DETAILED DESCRIPTION OF THE INVENTION

The disc discriminating device of the invention including a conductor and a sensing circuit determines whether the tray has a disc according to whether the sensing circuit is conducted or not. Despite the invention is exemplified by a preferred embodiment stated below, the scope of protection of the invention is not limited thereto.

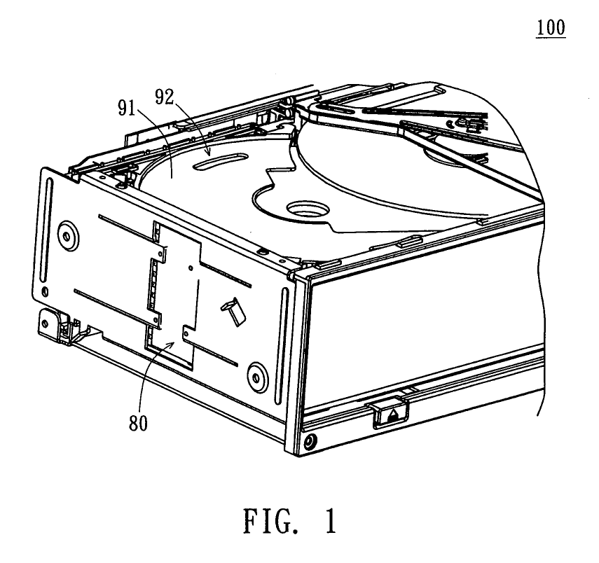

Referring to FIG. 1, a 3-D diagram of a disc changer according to a preferred embodiment of the invention is shown. According to the embodiment, the disc changer 100 includes a control system (not shown in the diagram), several trays 91 and a disc discriminating device 80. The trays 91 are stacked up with the bottom surface of one tray facing the top surface of the next tray, and each tray 91 has a recess 92. The disc discriminating device 80, disposed on one side of the trays 91, includes several sets of sensing components respectively corresponding to the several trays 91. When a disc is loaded into the tray 91, the disc discriminating device 80 immediately determines whether each tray 91 has a disc loaded therein, and outputs several signals accordingly. The control system receives the signals, drives the tray having the disc, and carries the disc to a read position.

It is noteworthy that each of the trays 91 has a set of sensing components correspondingly disposed therein for respectively determining whether each of the trays 91 has a disc, and accordingly outputs respective signals to the control system. The control system receives the signals, and then drives the tray having a disc and read the data from the disc.

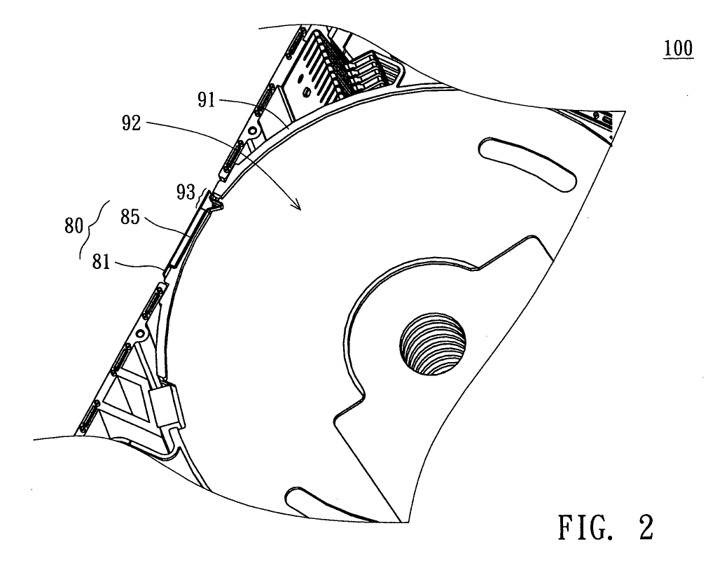

Referring to FIG. 2, a top view of the disc changer of FIG. 1 is shown. In the disc changer 100, the trays 91 are stacked up with the bottom surface of one tray facing the top surface of the next tray. Each of the trays 91 has a recess 92, and the sidewall of the trays 91 around the recess 92 has an aperture 93.

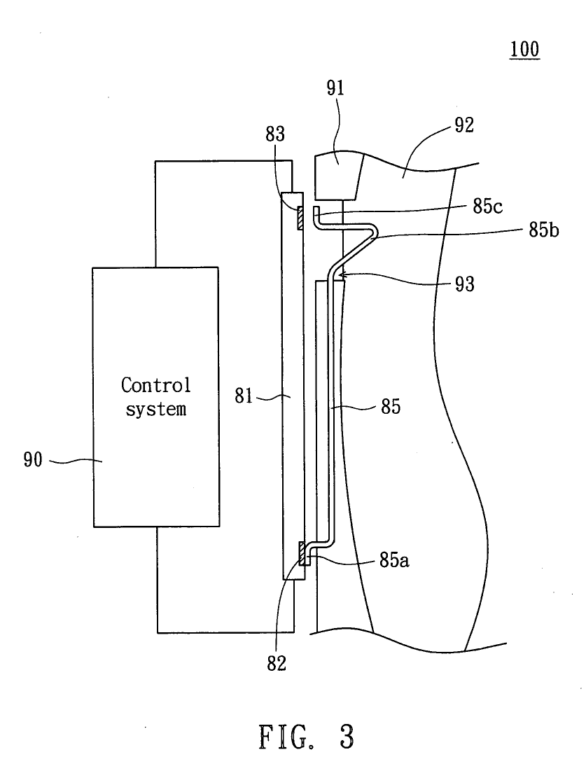

Referring to FIG. 3, a partial enlarged diagram of a disc discriminating device when no disc is loaded into the disc changer of FIG. 2 is shown. The disc discriminating device 80 includes several sets of sensing components. Each set of the sensing components includes a sensing circuit and a conductor 85. The sensing circuit, which can be disposed on the circuit board 81 for instance, has a first contact 82 and a second contact 83. The first contact 82 and the second contact 83 are selectively conducted together. When the first contact 82 is electrically connected to the second contact 83, the sensing circuit accordingly outputs a signal. The conductor 85 has a first end 85a, a protrusion 85b and a second end 85c. The first end 85a is electrically connected to the first contact 82 of the sensing circuit. The protrusion 85b penetrates an aperture 93 disposed on a sidewall of the recess 92 and protrudes to the recess 92. The second end 85c, extended to the sensing circuit, is separated by an interval from the second contact 83.

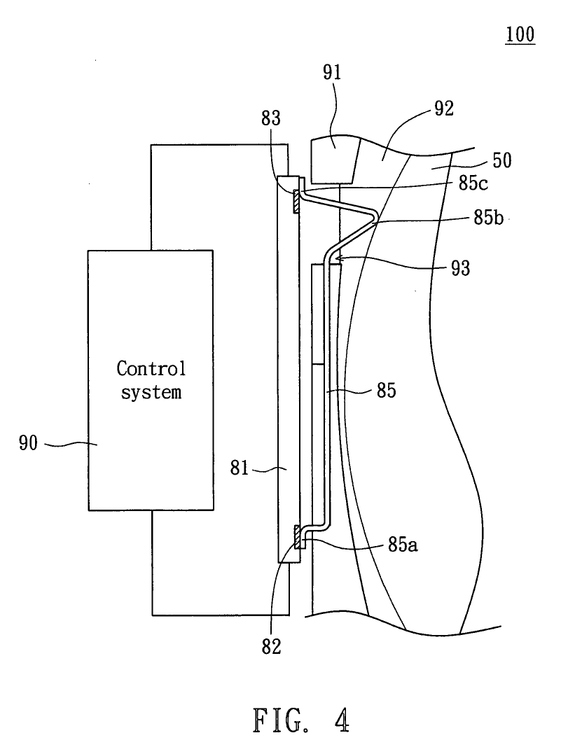

Referring to FIG. 4, a partial enlarged diagram of a disc discriminating device showing a disc is loaded into the disc changer of FIG. 2 is shown. When a disc 50 is loaded into the recess 92, the protrusion 85b positioned in the recess 92 is squeezed by the disc 50 for the second end 85c of the conductor to be electrically connected to the second contact 83, so that the first contact 82 is conducted to the second contact 83 and that the sensing circuit outputs a signal, signifying that the recess 92 has a disc. Meanwhile, the control system 90 receives the signal to be displayed on the operating interface. The user selects to play a disc through an operating interface, and then the control system 90 drives the selected tray 91 and carries the disc 50 to a read position such as atop of the optical pick-up head for instance.

Preferably, the conductor 85 is a metal elastic piece, and the first end 85a of the conductor is buckled to be connected to the first contact 82, or screwed to be connected to the first contact 82.

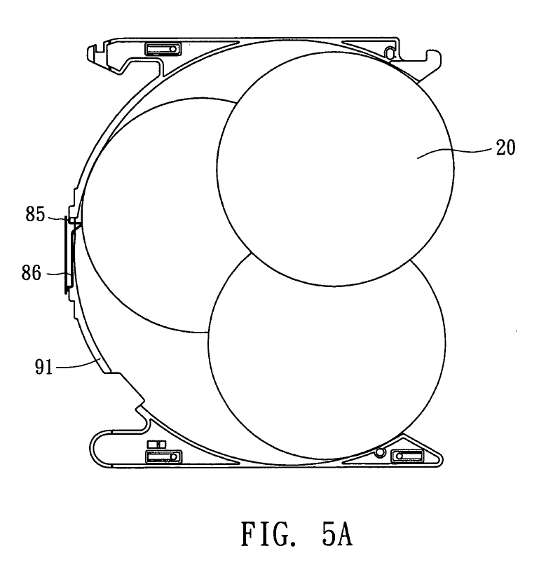

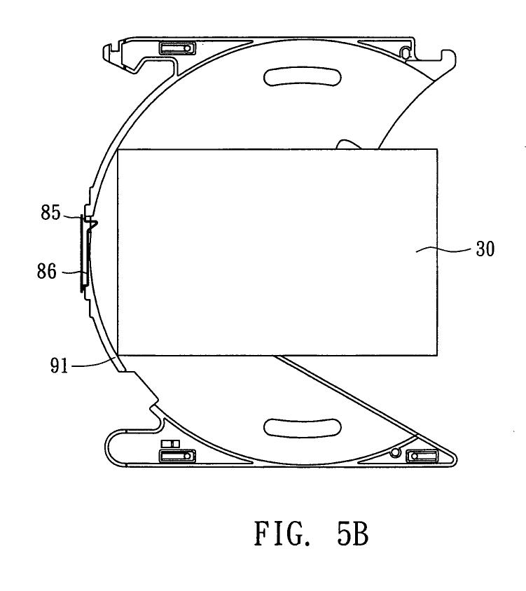

The disc discriminating device of the invention further can distinguish suitable discs from incorrect ones to prevent the incorrect discs from being stuck in the disc changer. Referring to FIGS. 5A and 5B, two top views showing a small-sized disc is loaded into the disc changer according to the embodiment are shown. When a small-sized disc 20 is loaded into the recess 92, the disc 50 would not squeeze the protrusion 85b positioned in the recess 92, the second end 85c of the conductor can not be electrically connected to the second contact 83, the first contact 82 and the second contact 83 are not conducted, so that the sensing circuit would indicate that no disc is within the recess 92 and that the tray 91 can not carry the disc 50 to atop of the optical pick-up head. Similarly as shown in FIG. 5B, when a squared disc 30 is loaded in the recess 92, the sensing circuit would indicate the recess 92 does not have any disc loaded, neither can the tray 91 carry the disc 50 to atop of the optical pick-up head.

The disc changer disclosed in above embodiment of the invention uses a disc discriminating device to determine whether the tray has an optical disc or not according to whether a sensing circuit is conducted or not. The disc discriminating device is capable of determining whether the tray has a disc immediately after the cartridge is completely loaded into the disc changer. The determining process is completed almost spontaneously when the entire cartridge is loaded, and takes a very short duration of time, largely increasing the efficiency of the disc changer. Moreover, during the determining process, the tray does not need to be withdrawn from the cartridge, largely reducing reciprocal movements, hence prolonging the lifespan of the disc changer. Unlike the conventional disc determining method which is incapable of determining the disc size, the disc discriminating device of the present embodiment is capable of determining whether the tray has an optical disc of suitable size or not. The disc determining device would display “No disc in the tray” when no optical disc of suitable side is in the tray, lest a small-sized optical disc would slide to the movement of the optical disc drive through the aperture, damaging the movement or causing the disc to be locked and can not be released.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A disc discriminating device disposed in a disc changer, wherein the disc changer comprises at least a tray having a recess, the disc discriminating device comprising:
a sensing circuit having a first contact and a second contact, wherein when the first contact is electrically connected to the second contact, the sensing circuit is conducted to output a signal, signifying that the recess has a disc loaded therein; and
a conductor having a first end, a protrusion and a second end, wherein the first end electrically connected to the first contact, the second end and the second contact separated by an interval when the protrusion protrudes to the recess, the disc squeezing the protrusion to be outside the recess when the disc is loaded into the recess, so that the second end electrically connected to the second contact, whereby the sensing circuit is conducted to output the signal.

2. The disc discriminating device according to claim 1, wherein a sidewall of the tray around the recess has an aperture, the protrusion penetrating the aperture and protruding to the recess.

3. The disc discriminating device according to claim 1, wherein the disc changer further comprises a plurality of trays stacked up with the bottom surface of one tray facing the top surface of the next tray, a plurality of conductors and a plurality of sensing circuits correspondingly disposed on one side of the trays.

4. The disc discriminating device according to claim 3, wherein the disc discriminating device further comprises a circuit board, disposed on the side of the trays, the sensing circuits correspondingly disposed thereon.

5. The disc discriminating device according to claim 1, wherein the disc discriminating device further comprises a circuit board disposed on one side of the tray, and the sensing circuit is disposed on the circuit board.

6. The disc discriminating device according to claim 1, wherein the conductor is a metal elastic piece.

7. The disc discriminating device according to claim 1, wherein the first end of the conductor is buckled with the first contact of the sensing circuit.

8. The disc discriminating device according to claim 1, wherein the first end of the conductor is screwed to be connected with the first contact of the sensing circuit.

9. A disc changer, comprising:
a plurality of trays stacked up with the bottom surface of one tray facing the top surface of the next tray;
a disc discriminating device having a plurality of sensing components respectively corresponding to the trays for determining whether each tray has a disc loaded therein and then outputting a plurality of signals accordingly; and
a control system receiving the signals and accordingly driving the trays to place the disc at a read position.

10. The disc changer according to claim 9, wherein the sensing components comprises:
a plurality of sensing circuits each having a first contact and a second contact, wherein when the first contact is electrically connected to the second contact, the sensing circuit is conducted to output a signal, signifying that the recess has a disc loaded therein; and
a plurality of conductors each having a first end, a protrusion and a second end, each first end electrically connected to each first contact, the second end and the second contact separated by an interval when one of the protrusions protrudes to the recess, the disc squeezes the protrusion to be outside the recess when the disc is loaded into one of the recess, so that the second end is electrically connected to the second contact, whereby the sensing circuit is conducted to output the signal;
wherein only after having received the signal can the control system drive the tray and place the disc at a read position.

11. The disc changer according to claim 10, wherein a sidewall of the tray around the recess has an aperture, and the protrusion penetrating the aperture and protruding to the recess.

12. The disc changer according to claim 11, wherein the disc changer further comprises a circuit board, the sensing circuits is disposed thereon.

13. The disc changer according to claim 12, wherein the conductors and the sensing circuits are disposed on one side of the trays, the circuit board is disposed on the same side for the sensing circuits to be correspondingly disposed thereon.

14. The disc changer according to claim 10, wherein each conductor is a metal elastic piece.

15. The disc changer according to claim 10, wherein the first end of the conductor is buckled with the first contact of the sensing circuit.

16. The disc changer according to claim 10, wherein the first end of the conductor is screwed to be connected with the first contact of the sensing circuit.
